(19) United States
(12) Patent Application Publication
(10) Pub. No.: US 2016/0289490 A1
(43) Pub. Date: Oct. 6, 2016

(54) RESIN COMPOSITION, PRIMER COATING MATERIAL, AND PLASTIC MOLDED ARTICLE COATED THEREWITH

(71) Applicant: DIC CORPORATION, Tokyo (JP)

(72) Inventors: Masataka ATSUMI, Osaka (JP); Masaharu TAKAHASHI, Osaka (JP)

(21) Appl. No.: 14/778,558

(22) PCT Filed: Mar. 12, 2014
(86) PCT No.: PCT/JP2014/056466

§ 371 Date: Sep. 18, 2015

(30) Foreign Application Priority Data
Mar. 22, 2013 (JP) 2013-059920

(51) Int. Cl. C09D 151/06; C09D 5/00; C08J 7/04; C08F 255/00

(52) U.S. Cl. CPC C09D 151/06; C08F 255/00; C09D 5/002; C08J 7/047; C08J 7/042; C08J 2377/00; C08J 2451/06; C08J 2400/00

(57) ABSTRACT

A resin composition is proved which is obtained by a polymerization reaction of a vinyl monomer mixture in the presence of an acid modified polyolefin resin, the vinyl monomer mixture containing as an essential component, a phosphorus atom-containing vinyl monomer and at least one type of vinyl monomer selected from the group consisting of ethyl acrylate, n-butyl acrylate, and 2-ethylhexyl acrylate and having a glass transition temperature of −5° C. to 45° C. which is calculated by FOX's equation. In the resin composition described above, the mass ratio of the vinyl monomer mixture to the acid modified polyolefin resin is in a range of 99/1 to 60/40. Since capable of forming a coating film which has a high adhesion to a plastic and a top coating film and an excellent water resistance, this resin composition can be preferably used for a primer coating material.

### TECHNICAL FIELD

The present invention relates to a resin composition capable of forming a coating film which has a high adhesion to a plastic substrate and a top coating film and an excellent water resistance, a primer coating material, and a plastic molded article coated with the above coating material.

### BACKGROUND ART

Since having excellent weather resistance, flexibility, strength, adhesion, and the like, an acrylic resin has been widely used for applications of coating materials, ink, adhesives, synthetic leathers, and the like. In particular, in the coating material application, as base resins of coating materials which coat various types of substrates (such as metal, wood, paper, and plastic) in the fields of automobiles, electric home appliances, building materials, and the like, acrylic resins have been developed so as to have specifically required characteristics.

In addition, as for a plastic molded article, a resin, such as an acrylonitrile-butadiene-styrene copolymer, a polycarbonate, or a polystyrene, has been frequently used as a base material in consideration of its cost and good moldability. In addition, in order to achieve the reduction in weight which is required for plastic molded articles, the reduction in thickness thereof has been pursued; however, by the reduction in thickness, the mechanical strength is disadvantageously decreased. Accordingly, glass fiber reinforced plastic molded articles, such as a glass fiber reinforced polyamide and a glass fiber reinforced polycarbonate, each having a higher mechanical strength have started to be used.

However, since the polarity of a glass fiber reinforced plastic is significantly different from that of a related common plastic, an acrylic resin is disadvantageously unable to exhibit a sufficient adhesion to the glass fiber reinforced plastic although capable of forming a coating film having an excellent adhesion to the other resins.

As a resin composition which improves the adhesion to this glass fiber reinforced plastic, a resin composition obtained by polymerization of a phosphorus atom-containing vinyl monomer in the presence of a polyol has been proposed (for example, see PTL 1). However although improving the adhesion to a substrate, a coating film obtained from a coating material using this resin composition has an inferior adhesion to a top coating film, and in addition, since this resin composition is a two-component type composition separately using a curing agent, a short pot life and inferior workability have been problems. Accordingly, there has been desired a one-component coating material capable of forming a coating film which has an excellent adhesion without influenced by the types of substrate materials, which particularly has an excellent adhesion to a glass fiber reinforced plastic and a top coating film, and which has an excellent water resistance.

### CITATION LIST

### Patent Literature

PTL 1: Japanese Unexamined Patent Application Publication No. 2009-270031

### SUMMARY OF INVENTION

### Technical Problem

An object of the present invention is to provide a resin composition capable of forming a coating film which has a high adhesion to a plastic and a top coating film and an excellent water resistance, a primer coating material, and a plastic molded article coated with the above coating material.

### Solution to Problem

Through intensive research to achieve the above object, the present inventors found that by the use of a resin composition obtained by a polymerization reaction of a specific vinyl monomer mixture (A) in the presence of an acid-modified polyolefin resin (B), a coating film having a high adhesion to a plastic and a top coating film and an excellent water resistance can be obtained, and hence, the present invention was made.

That is, the present invention relates to a resin composition obtained by a polymerization reaction of a vinyl monomer mixture (A) in the presence of an acid-modified polyolefin resin (B); a primer coating material; and a plastic molded article coated with the coating material described above. In the resin composition described above, the vinyl monomer mixture (A) contains as an essential component, a phosphorus atom-containing vinyl monomer (a1) and at least one type of vinyl monomer (a2) selected from the group consisting of ethyl acrylate, n-butyl acrylate, and 2-ethylhexyl acrylate and has a glass transition temperature of −5° C. to 45° C. which is calculated by FOX's equation, and the mass ratio [(A)/(B)] of the vinyl monomer mixture (A) to the acid-modified polyolefin resin (B) is in a range of 99/1 to 60/40.

### Advantageous Effects of Invention

Since capable of forming a coating film which has a high adhesion to a plastic and a top coating film and an excellent water resistance, the resin composition of the present invention is effectively used for a primer coating material, and this coating material can be coated on various types of plastic molded articles. Accordingly, the resin composition of the present invention may be preferably used for coating materials which coat housings of electronic devices, such as a mobile phone, a smart phone, a tablet terminal, a personal computer, a digital camera, and a game machine; housings of electric home appliances, such as a television, a refrigerator, a washing machine, and an air conditioner; interior materials of various types of vehicles, such as an automobile and a railroad vehicle; and various types of goods, such as a bathtub and a fishing tackle.

### DESCRIPTION OF EMBODIMENTS

A resin composition of the present invention is a resin composition obtained by a polymerization reaction of a vinyl monomer mixture (A) in the presence of an acid-modified polyolefin resin (B), the vinyl monomer mixture (A) containing as an essential component, a phosphorus atom-containing vinyl monomer (a1) and at least one type of vinyl monomer (a2) selected from the group consisting of ethyl acrylate, n-butyl acrylate, and 2-ethylhexyl acrylate and having a glass transition temperature of −5° C. to 45° C. which is calculated by FOX's equation, and the mass ratio [(A)/(B)] of the vinyl monomer mixture (A) to the acid-modified polyolefin resin (B) is in a range of 99/1 to 60/40.

In addition, in the present invention, the glass transition temperature calculated by FOX's equation is a temperature obtained by calculation using the following equation.

1/Tg=W1/Tg1+W2/Tg2+ - - - FOX's equation:

(Tg: glass transition temperature to be obtained, W1: weight fraction of component 1, Tg1: glass transition temperature of homopolymer of component 1)

As the value of the glass transition temperature of the homopolymer of each component, the value described in “Adhesive Technology Handbook” published by NIKKAN KOGYO SHIMBUN, LTD., or “Polymer Handbook” published by Wiley-Interscience is to be used. In addition, in the present invention, the glass transition temperature of a homopolymer of 2-methacryloyloxyethyl acid phosphate (LIGHT ESTER P-1M manufactured by KYOEISHA CHEMICAL Co., Ltd.) is regarded as 50° C.

Hereinafter, the glass transition temperature which is calculated by this FOX's equation is abbreviated as the “designed Tg”.

First, the vinyl monomer mixture (A) will be described. This vinyl monomer mixture (A) is a mixture containing as an essential component, a phosphorus atom-containing vinyl monomer (a1) and at least one type of vinyl monomer (a2) selected from the group consisting of ethyl acrylate, n-butyl acrylate, and 2-ethylhexyl acrylate, and having a glass transition temperature of −5° C. to 45° C. which is calculated by FOX's equation.

Although the vinyl monomer (a1) described above includes at least one phosphorus atom-containing vinyl monomer, among those monomers, a vinyl monomer having a phosphate group is preferable, and for example, 2-(meth)acryloyloxyethyl acid phosphate, 3-methacryloyloxypropyl acid phosphate, methacryloyloxy polyoxyethylene glycol acid phosphate, or methacryloyloxy polyoxypropylene glycol acid phosphate may be mentioned. In addition, the vinyl monomers (a1) mentioned above may be used alone, or at least two types thereof may be used in combination.

Incidentally, in the present invention, “(meth)acrylic acid” indicates at least one of methacrylic acid and acrylic acid, “(meth)acrylate” indicates at least one of methacrylate and acrylate, and “(meth)acryloyl group” indicates at least one of a methacryloyl group and an acryloyl group.

The vinyl monomer (a2) includes at least one type of vinyl monomer selected from the group consisting of ethyl acrylate, n-butyl acrylate, and 2-ethylhexyl acrylate. Among those monomers, ethyl acrylate is preferable since the appearance of a coating film to be obtained is improved.

As monomers other than the vinyl monomers (a1) and (a2) to be used as the components of the vinyl monomer mixture (A), for example, there may be mentioned styrene, (meth)acrylic acid, methyl (meth)acrylate, ethyl methacrylate, n-propyl (meth)acrylate, isopropyl (meth)acrylate, n-butyl methacrylate, isobutyl (meth)acrylate, t-butyl (meth)acrylate, n-pentyl (meth)acrylate, n-hexyl (meth)acrylate, n-heptyl (meth)acrylate, n-octyl (meth)acrylate, 2-ethylhexyl methacrylate, nonyl (meth) acrylate, decyl (meth)acrylate, dodecyl (meth)acrylate, tridecyl (meth)acrylate, cetyl (meth)acrylate, stearyl (meth)acrylate, behenyl (meth)acrylate, cyclohexyl (meth)acrylate, 4-tert-butylcyclohexyl (meth)acrylate, isobornyl (meth)acrylate, dicyclopentanyl (meth) acrylate, benzyl (meth) acrylate, acrylamide, N,N-dimethyl (meth) acrylamide, (meth) acrylonitrile, 3-(meth)acryloylpropyl trimethoxy silane, N, N-dimethylaminoethyl (meth)acrylate, glycidyl (meth)acrylate, α-methyl styrene, p-methyl styrene, p-methoxy styrene, 2-hydroxyethyl (meth)acrylate, 3-hydroxypropyl (meth) acrylate, 4-hydroxy-n-butyl (meth)acrylate, 2-hydroxypropyl (meth)acrylate, 2-hydroxy-n-butyl (meth)acrylate, 3-hydroxy-n-butyl (meth)acrylate, 1,4-cyclohexanedimethanol mono(meth)acrylate, glycerine mono(meth)acrylate, polyethylene glycol mono(meth)acrylate, polypropylene glycol mono(meth)acrylate, 2-hydroxy-3-phenoxypropyl (meth)acrylate, 2-(meth)acryloyloxyethyl-2-hydroxyethyl phthalate, lactone-modified (meth)acrylate with a hydroxy group at the terminal. In addition, although those vinyl monomers may be used alone, or at least two types thereof may be used in combination, a vinyl monomer (a3) having a hydroxy group is preferably contained since the appearance of the coating film to be obtained is improved, and furthermore, a vinyl monomer having a secondary hydroxy group is more preferably contained since the storage stability of the resin composition of the present invention is improved.

Although the vinyl monomer mixture (A) contains the vinyl monomer (a1) and the vinyl monomer (a2) as an essential component, since the adhesion of the coating film to be obtained is improved, the mass rate of the vinyl monomer (a1) and the mass rate of the vinyl monomer (a2) are preferably in a range of 0.01 to 1.5 parts by mass and in a range of 20 to 70 parts by mass, respectively, and are more preferably in a range of 0.1 to 0.5 parts by mass and in a range of 25 to 55 parts by mass, respectively.

In addition, although the designed Tg of the vinyl monomer mixture (A) is −5° C. to 45° C., since the adhesion of the coating film to be obtained is improved, the designed Tg is preferably 0° C. to 35° C.

Next, the acid modified polyolefin resin (B) will be described. This acid modified polyolefin resin (B) is a polyolefin resin modified with a carboxylic acid.

As the carboxylic acid, for example, there may be mentioned an acid anhydride, such as maleic anhydride, citraconic anhydride, or itaconic anhydride; or an unsaturated carboxylic acid, such as (meth)acrylic acid, maleic acid, or fumaric acid.

As the polyolefin resin, for example, there may be mentioned a polypropylene, a high density polyethylene, a ultra high molecular weight polyethylene, a linear low density polyethylene, a low density polyethylene, a ultra low density polyethylene, a ultra-very low density polyethylene, a poly(methyl pentene), an ethylene-propylene copolymer, a propylene-1-butene random copolymer, a propylene-ethylene-1-butene random copolymer, a copolymer of propylene and an α-olefin having 5 to 12 carbon atoms, a propylene-nonconjugated diene copolymer, an ethylene-nonconjugated diene copolymer, an ethylene-propylene-nonconjugated diene copolymer, a polybutene, an ethylene-vinyl acetate copolymer, an ethylene-vinyltrimethoxysilane copolymer, an ethylene-methyl acrylate copolymer, an ethylene-ethyl acrylate copolymer, an ethylene-methyl methacrylate copolymer, a styrene-butadiene block copolymer, and hydrogenated products thereof. In addition, those polyolefin resins may be used alone, or at least two types thereof may be used in combination.

As a method to obtain the resin composition of the present invention by a polymerization reaction of the vinyl monomer mixture (A) in the presence of the acid modified polyolefin resin (B), in view of the storage stability of the resin, a method in which graft polymerization is performed by addition of the vinyl monomer mixture (A) and a polymerization initiator to the acid modified polyolefin resin (B) dissolved in an organic solvent is preferable.

As the above organic solvent, for example, there may be mentioned an aromatic hydrocarbon compound, such as toluene or xylene; an alicyclic hydrocarbon compound, such as cyclohexane, methylcyclohexane, or ethylcyclohexane; a ketone compound, such as acetone, methyl ethyl ketone, methyl isobutyl ketone, or cyclohexanone; an ester compound, such as ethyl acetate, n-butyl acetate, or propylene glycol monomethyl ether acetate; an alcohol compound, such as n-butanol, isopropyl alcohol, or cyclohexanol; a glycol compound, such as ethylene glycol monobutyl ether or propylene glycol monomethyl ether; an aliphatic hydrocarbon compound, such as heptane, hexane, octane, or mineral turpentine. Among those mentioned above, in view of the storage stability of the resin, the aromatic hydrocarbon compound, the ketone compound, and the glycol compound are preferable.

As the polymerization initiator, for example, there may be mentioned organic peroxides including: a ketone peroxide compound, such as cyclohexanone peroxide, 3,3,5-trimethylcyclohexanone peroxide, or methylcyclohexanone peroxide; a peroxy ketal compound, such as 1,1-bis(tert-butylperoxy)-3,3,5-trimethylcyclohexane, 1,1-bis(tert-butylperoxy)cyclohexane, n-butyl-4,4-bis(tert-butylperoxy)valerate, 2,2-bis(4,4-di-tert-butylperoxycyclohexyl)propane, 2,2-bis(4,4-di-tert-amylperoxycyclohexyl)propane, 2,2-bis(4,4-di-tert-hexylperoxycyclohexyl)propane, 2,2-bis(4,4-di-tert-octylperoxycyclohexyl)propane, or 2,2-bis(4,4-dicumylperoxycyclohexyl)propane; a hydroperoxide compound, such as cumene hydroperoxide or 2,5-dimethylhexane-2,5-di-hydroperoxide; a dialkyl peroxide compound, such as 1,3-bis(tert-butylperoxy-m-isopropyl)benzene, 2,5-dimethyl-2,5-di(tert-butylperoxy)hexane, diisopropylbenzene peroxide, or tert-butylcumyl peroxide; a diacyl peroxide compound, such as decanoyl peroxide, lauroyl peroxide, benzoyl peroxide, or 2,4-dichlorobenzoyl peroxide; a peroxycarbonate compound, such as bis(tert-butylcyclohexyl)peroxydicarbonate; and a peroxyester compound, such as tert-butylperoxy-2-ethylhexanoate, tert-butyl peroxybenzoate, or 2,5-dimethyl-2,5-di(benzoyl peroxy)hexane; or azo compounds, such as 2,2′-azobisisobutyronitrile and 1,1′-azobis (cyclohexane-1-carbonitrile).

Although the mass ratio [(A)/(B)] of the vinyl monomer mixture (A) to the acid-modified polyolefin resin (B) is in a range of 99/1 to 60/40, in consideration of the storage stability of the resin and the adhesion to a top coating film having a high polarity, a range of 99/1 to 70/30 is preferable, and a range of 99/1 to 80/20 is more preferable.

Even if having no hydroxy groups, the resin composition of the present invention may not cause any practical problems in use; however, since the appearance of the coating film to be obtained is improved, the hydroxy group value is preferably in a range of 5 to 50, and since the water resistance is improved, the hydroxy group value is more preferably in a range of 10 to 35.

In view of the adhesion of the coating film to be obtained and the workability, the weight average molecular weight (Mw) of the resin composition of the present invention is preferably in a range of 15,000, 200,000 and more preferably in a range of 25,000 to 130,000. In this embodiment, the weight average molecular weight (Mw) is a polystyrene conversion value based on gel permeation chromatographic (hereinafter abbreviated as “GPC”) measurement.

Since the resin composition of the present invention has an excellent storage stability, and the coating film to be obtained therefrom has a high adhesion to a plastic substrate and a top coating film and also has an excellent water resistance, the resin composition of the present invention may be preferably used for a primer coating material.

Although containing the resin composition of the present invention, a primer coating material of the present invention may also contain as other compounding materials, additives, such as a solvent, an anti-foaming agent, a viscosity adjusting agent, a light resistance stabilizer, a weather resistance stabilizer, a heat resistance stabilizer, a UV absorber, an antioxidant, a leveling agent, and a pigment dispersant.

As a method for coating the primer coating material of the present invention, for example, there may be mentioned a spray, an applicator, a bar coater, a gravure coater, a roll coater, a comma coater, a knife coater, an air knife coater, a curtain coater, a kiss coater, a shower coater, a wheeler coater, a spin coater, a dipping, or a screen printing method. In addition, as a method for forming a coating film after the coating, for example, a method in which drying is performed in a range of room temperature to approximately 100° C. may be mentioned.

In addition, when various top coating materials are coated on the coating film of the primer coating material of the present invention, various functions can be imparted to the surface of the coating film in accordance with the application.

As the top coating material described above, for example, a coating material containing as a primary component, a UV curable resin, an acrylic resin, a polyurethane resin, a polyester resin, a melamine resin, an epoxy resin, or the like may be used.

The primer coating material of the present invention may be used as a coating material which coats various types of plastic molded articles. As the plastic molded articles to which the primer coating material of the present invention can be applied, for example, there may be mentioned housings of electronic devices, such as a mobile phone, a smart phone, a tablet terminal, a personal computer, a digital camera, and a game machine; housings of electric home appliances, such as a television, a refrigerator, a washing machine, and an air conditioner; interior materials of various typed of vehicles, such as an automobile and a railroad vehicle; and various goods, such as a bathtub and a fishing tackle. Among those mentioned above, since the coating film to be obtained and the substrate form a high adhesion therebetween, a glass fiber reinforced plastic molded article which uses a glass fiber reinforced plastic as the substrate is preferable.

### EXAMPLES

Hereinafter, the present invention will be described in more detail with reference to concrete examples. In addition, the hydroxy group value of a polymer was measured in accordance with JIS test method K 0070-1992. In addition, the weight average molecular weight (Mw) was measured under the following GPC measurement conditions.

### [GPC Measurement Conditions]

Measurement Apparatus: high speed GPC apparatus (“HLC-8220GPC” manufactured by Tosoh Corp.)

Column: the following columns manufactured by Tosoh Corp. connected in series were used.

“TSKgel G5000” (7.8 mm I.D.×30 cm)×one column

“TSKgel G4000” (7.8 mm I.D.×30 cm)×one column

“TSKgel G3000” (7.8 mm I.D.×30 cm)×one column

“TSKgel G2000” (7.8 mm I.D.×30 cm)×one column

Detector: RI (differential Refractometer)

Column temperature: 40° C.

Eluent: tetrahydrofuran (THF)

Flow rate: 1.0 mL/min

Injection volume: 100 μL (a tetrahydrofuran solution having a sample concentration of 4 mg/mL)

Standard sample: the calibration curve was formed using the following monodisperse polystyrenes.

### (Monodisperse Polystyrenes)

“TSKgel Standard polystyrene A-500” manufactured by Tosoh Corp.”

“TSKgel Standard polystyrene A-1000” manufactured by Tosoh Corp.”

“TSKgel Standard polystyrene A-2500” manufactured by Tosoh Corp.”

“TSKgel Standard polystyrene A-5000” manufactured by Tosoh Corp.”

“TSKgel Standard polystyrene F-1” manufactured by Tosoh Corp.”

“TSKgel Standard polystyrene F-2” manufactured by Tosoh Corp.”

“TSKgel Standard polystyrene F-4” manufactured by Tosoh Corp.”

“TSKgel Standard polystyrene F-10” manufactured by Tosoh Corp.”

“TSKgel Standard polystyrene F-20” manufactured by Tosoh Corp.”

“TSKgel Standard polystyrene F-40” manufactured by Tosoh Corp.”

“TSKgel Standard polystyrene F-80” manufactured by Tosoh Corp.”

“TSKgel Standard polystyrene F-128” manufactured by Tosoh Corp.”

“TSKgel Standard polystyrene F-288” manufactured by Tosoh Corp.”

“TSKgel Standard polystyrene F-550” manufactured by Tosoh Corp.”

### Example 1

### Synthesis and Evaluation of Resin Composition (1)

To a flask equipped with a cooling tube, a thermometer, a dripping funnel, and a stirrer, 540 parts by mass of toluene, 430 parts by mass of methyl ethyl ketone, and 100 parts by mass of an acid modified polyolefin resin (“AUROREN 350S”, a maleic anhydride modified polyolefin resin, manufactured by Nippon Paper Industries Co., Ltd.) were charged, and the acid modified polyolefin resin was dissolved at an inside temperature of 80° C. Next, a mixture containing 55 parts by mass of styrene, 310 parts by mass of methyl methacrylate, 480 parts by mass of ethyl acrylate, 50 parts by mass of 2-hydroxyethyl methacrylate, 3 parts by mass of methacrylic acid, 2 parts by mass of 2-methacryloyloxyethyl acid phosphate (LIGHT ESTER P-1M manufactured by KYOEISHA CHEMICAL Co., Ltd.), 12 parts by mass of t-butylperoxy-2-ethylhexanoate, and 250 parts by mass of toluene was dripped over 6 hours. After the dripping was completed, a reaction was performed at 80° C. for 8 hours, so that a solution of a resin composition (1) having a nonvolatile component of 45 percent by mass, a weight average molecular weight of 78,000, and a solid-component hydroxy group value of 23.4 was obtained.

### [Evaluation of Storage Stability]

After the solution of the resin composition (1) obtained as described above was stored still at 0° C. for 3 months, the appearance of the solution was observed by visual inspection, and the storage stability was evaluated in accordance with the following criteria.

⊙: No change.
◯: Turbidity slightly increases.
Δ: A small amount of a solid component is generated.
x: A large amount of a solid component is generated.

### [Preparation of Primer Coating Material]

By addition of a thinner (diacetone alcohol/methyl isobutyl ketone/ethyl acetate/butyl acetate=30/40/20/10 (percent by mass)) to the resin composition (1) obtained as described above, the viscosity adjustment was performed to have an approximately 9 seconds by an Iwata cup, so that a primer coating material (1) was obtained.

### [Preparation of Top Coating Material]

By addition of 3 parts by mass of a photopolymerization initiator (“IRGACURE 184”, 1-hydroxycyclohexyl phenyl ketone, manufactured by BASF Japan Ltd.) and a thinner (diacetone alcohol/methyl isobutyl ketone/ethyl acetate/butyl acetate=30/40/20/10 (percent by mass)) to 118 parts by mass of a UV curable resin (“UNIDIC V-4001EA” manufactured by DIC Corp.), the viscosity adjustment was performed to have an approximately 10 seconds by an Iwata cup, so that a top coating material was formed.

### [Formation of Primer Coating Film]

A primer coating material (1) obtained as described above was applied on a glass fiber reinforced polyamide (RENY NXG5945S manufactured by Mitsubishi Engineering-Plastic Corp.) by spray coating so as to obtain a dry film thickness of 15 μm and was then dried at 80° C. for 5 minutes by heating, thereby forming a primer coating film (1).

### [Formation of Composite Coating Film]

The top coating material obtained as described above was applied by spray coating on the primer coating film (1) obtained as described above so as to have a dry film thickness of 10 μm and was then dried at 60° C. for 10 minutes by heating. Subsequently, UV ray irradiation was performed at a radiation dose of 0.8 J/cm² using a high pressure mercury lamp having an output of 80 W/cm, so that a composite coating film (1) was formed.

### [Evaluation of Initial Adhesion]

The primer coating film (1) and the composite coating film (1) obtained as described above were each measured in accordance with a cross-cut adhesion test method of JIS K-5400. Cuts each having a width of 1 mm were formed in the coating film so as to obtain 100 grids. Subsequently, a cellophane tape was adhered so as to cover all the grids and was then immediately peeled away, and from the number of remaining grids which were still adhered, the adhesion was evaluated in accordance with the following criteria. Evaluation Criteria of Primer Coating Film

◯: 100 grids
Δ: 50 to 99 grids
x: 49 grids or less

### Evaluation Criteria of Composite Coating Film

◯: 100 grids of each of the primer coating film and the top coating film.
Δ: 100 grids of the primer coating film and 99 grids or less of the top coating film, or 50 to 99 grids of the primer coating film.
x: 49 grids or less of the primer coating film.
[Evaluation of Water Resistance (Adhesion after Water Resistance Test)]

After a test sample having the composite coating film (1) obtained as described above was immersed in hot water at 40° C. for 24 hours and was then recovered, the adhesion after a water resistance test was evaluated in a manner similar to that of the evaluation of the above initial adhesion.

### [Evaluation of Pot Life]

After the primer coating material (1) obtained as described above was stored still at 20° C., the time at which the fluidity thereof was lost was measured, and the pot life was evaluated in accordance with the following criteria.

◯: 24 hours or more
x: less than 24 hours

### Examples 2 to 26

### Synthesis and Evaluation of Resin Compositions (2) to (26)

Except that the vinyl monomers and the acid modified polyolefin resin were changed to the compositions shown in the following Tables 1 to 3, the synthesis and the evaluation of resin compositions (2) to (26) were performed by an operation similar to that of Example 1.

### Comparative Examples 1 to 6

### Synthesis and Evaluation of Resin Compositions (R1) to (R6)

Except that the vinyl monomers and the acid modified polyolefin resin were changed to the compositions shown in the following Table 4, the synthesis and the evaluation of resin compositions (R1) to (R6) were performed by an operation similar to that of Example 1.

### Comparative Example 7

### Synthesis and Evaluation of Resin Composition (R7)

To a flask equipped with a cooling tube, a thermometer, a dripping funnel, and a stirrer, 70 parts by mass of toluene and 20 parts by mass of a polyether polyol resin (“PTG650” manufactured by Hodogaya Chemical Co., Ltd.) were charged, and heating was then performed to 100° C. Subsequently, a mixture containing 1 part by mass of 2-methacryloyloxyethyl acid phosphate (“LIGHT ESTER P-1M” manufactured by KYOEISHA CHEMICAL Co., Ltd.), 49 parts by mass of methyl methacrylate, 5 parts by mass of n-butyl methacrylate, 25 parts by mass of n-butyl acrylate, and 2 parts by mass of 2,2′-azobisisobutylonitrile was dripped over 4 hours while the temperature in the flask was maintained at 100° C. Next, after 0.1 parts by mass of 2,2′-azobisisobutylonitrile was charged 4 times at 30-minute intervals to the flask maintained at the same temperature as described above and was held for 1 hour, cooling was performed, so that a resin composition (R7) having a nonvolatile component of 60 percent by mass was obtained.

Except that the preparation of the primer coating material was changed to the following preparation method, the evaluation of the resin composition (R7) was performed by an operation similar to that of Example 1.

### [Preparation of Primer Coating Material]

After 100 parts by mass of the resin composition (R7) obtained as described above was mixed with 7 parts by mass of hexamethylene diisocyanate (DURANATE TPA-100, isocyanate content: 23.1%, manufactured by Asahi Kasei Chemicals Corp.) as a curing agent, by addition of a thinner (diacetone alcohol/methyl isobutyl ketone/ethyl acetate/butyl acetate=30/40/20/10 (percent by mass)) to the mixture thus prepared, the viscosity adjustment was performed to have an approximately 9 seconds by an Iwata cup, so that a primer coating material (R7) was obtained.

The composition, the characteristics, and the evaluation results of each of the resin compositions (1) to (26), the resin compositions (R1) to (R6), and the resin composition (R7) are shown in Tables 1 to 4.

### [Tg of Homopolymer of Each Vinyl Monomer]

In the present invention, the following values were used.

2-methacryloyloxyethyl acid phosphate (LIGHT ESTER P-1M manufactured by KYOEISHA CHEMICAL Co., Ltd.): 50° C., ethyl acrylate: −24° C., n-butyl acrylate: −56° C., 2-ethylhexyl acrylate: −70° C., 2-hydroxyethyl methacrylate: 55° C., 2-hydroxypropyl methacrylate: 26° C., 4-hydroxybutyl acrylate: −80° C., styrene: 100° C., methyl methacrylate: 105° C., methacrylic acid: 144° C., acrylic acid: 87° C., t-butyl methacrylate: 107° C., and n-butyl methacrylate: 20° C.

TABLE 1

| | | | | Example 1 | Example 2 | Example 3 | Example 4 | Example 5 |
|---|---|---|---|---|---|---|---|---|
| Resin composition | | | | (1) | (2) | (3) | (4) | (5) |
| Composition | Vinyl monomer | Vinyl monomer | 2-methacryloyoxyethyl | 0.2 | 0.2 | 0.2 | 0.2 | 0.2 |
| (parts by | mixture (A) | (a1) | acid phosphate | | | | | |
| mass) | | Vinyl monomer | Ethyl acrylate | 48 | 54 | 53 | 52 | 46 |
| | | (a2) | | | | | | |
| | | Vinyl monomer | 2-hydroxyethyl | 5 | 5 | 5 | 5 | 5 |
| | | (a3) | methacrylate | | | | | |
| | | Other vinyl | Styrene | 5.5 | 5.5 | 5.5 | 5.5 | 5.5 |
| | | monomers | Methyl methacrylate | 31 | 34 | 34 | 32 | 28 |
| | | | Methacrylic acid | 0.3 | 0.3 | 0.3 | 0.3 | 0.3 |

| | | | | | | |
|---|---|---|---|---|---|---|
| | Designed Tg (° C.) | 20 | 20 | 20 | 20 | 20 |
| Acid modified | Acid modified polyolefin resin (B-1) | 10 | 1 | 2 | 5 | 15 |
| polyolefin resin | | | | | | |
| (B) | | | | | | |

| | | | | | | |
|---|---|---|---|---|---|---|
| | Mass ratio [(A)/(B)] | 90/10 | 99/1 | 98/2 | 95/5 | 85/15 |
| Characteristic | Nonvolatile component (percent by mass) | 45 | 45 | 45 | 45 | 45 |
| value | Weight average molecular weight | 78,000 | 70,000 | 65,000 | 65,000 | 70,000 |
| | Hydroxy group value | 23.4 | 22.9 | 22.8 | 23.1 | 23.3 |
| Evaluation | Storage stability | ◯ | ◯ | ◯ | ◯ | ◯ |
| | Initial adhesion (primer coating film) | ◯ | ◯ | ◯ | ◯ | ◯ |
| | Initial adhesion (composite coating film) | ◯ | ◯ | ◯ | ◯ | ◯ |
| | Adhesion after water resistance test (composite coating film) | ◯ | Δ | ◯ | ◯ | ◯ |
| | Pot life | ◯ | ◯ | ◯ | ◯ | ◯ |

| | | | | Example 6 | Example 7 | Example 8 | Example 9 |
|---|---|---|---|---|---|---|---|
| Resin composition | | | | (6) | (7) | (8) | (9) |
| Composition | Vinyl monomer | Vinyl monomer | 2-methacryloyoxyethyl | 0.2 | 0.2 | 0.1 | 1 |
| (parts by | mixture (A) | (a1) | acid phosphate | | | | |
| mass) | | Vinyl monomer | Ethyl acrylate | 65 | 40 | 48 | 49 |
| | | (a2) | | | | | |
| | | Vinyl monomer | 2-hydroxyethyl | 5 | 5 | 5 | 5 |
| | | (a3) | methacrylate | | | | |
| | | Other vinyl | Styrene | 5.5 | 5.5 | 5.5 | 5.5 |
| | | monomers | Methyl methacrylate | 14 | 39 | 31.1 | 29.2 |
| | | | Methacrylic acid | 0.3 | 0.3 | 0.3 | 0.3 |

| | | | | | |
|---|---|---|---|---|---|
| | Designed Tg (° C.) | 0 | 20 | 20 | 20 |
| Acid modified | Acid modified polyolefin resin (B-1) | 10 | 10 | 10 | 10 |
| polyolefin resin | | | | | |
| (B) | | | | | |

| | | | | | |
|---|---|---|---|---|---|
| | Mass ratio [(A)/(B)] | 90/10 | 90/10 | 90/10 | 90/10 |
| Characteristic | Nonvolatile component (percent by mass) | 45 | 45 | 45 | 45 |
| value | Weight average molecular weight | 80,000 | 70,000 | 60,000 | 65,000 |
| | Hydroxy group value | 23.8 | 23.9 | 23.0 | 23.9 |
| Evaluation | Storage stability | ◯ | ◯ | ◯ | ◯ |
| | Initial adhesion (primer coating film) | ◯ | ◯ | ◯ | ◯ |
| | Initial adhesion (composite coating film) | ◯ | ◯ | ◯ | ◯ |
| | Adhesion after water resistance test (composite coating film) | ◯ | ◯ | ◯ | ◯ |
| | Pot life | ◯ | ◯ | ◯ | ◯ |

TABLE 2

| | | | | Example | Example | Example | Example | Example |
|---|---|---|---|---|---|---|---|---|
| | | | | 10 | 11 | 12 | 13 | 14 |
| Resin composition | | | | (10) | (11) | (12) | (13) | (14) |
| Composition | Vinyl monomer | Vinyl monomer | 2-methacryloyoxyethyl | 0.2 | 0.2 | 0.2 | 0.2 | 0.2 |
| (parts by | mixture (A) | (a1) | acid phosphate | | | | | |
| mass) | | Vinyl monomer | Ethyl acrylate | 49 | 49 | 48 | 47 | 49 |
| | | (a2) | | | | | | |
| | | Vinyl monomer | 2-hydroxyethyl | | 3 | 7 | 10 | 5 |
| | | (a3) | methacrylate | | | | | |
| | | | 2-hydroxypropyl | | | | | |
| | | | methacrylate | | | | | |
| | | Other vinyl | Styrene | 5.5 | 5.5 | 5.5 | 5.5 | |
| | | monomers | Methyl methacrylate | 35 | 32 | 29 | 27 | 36 |
| | | | Methacrylic acid | 0.3 | 0.3 | 0.3 | 0.3 | 0.3 |
| | | | Acrylic acid | | | | | |

| | | | | | | |
|---|---|---|---|---|---|---|
| | Designed Tg (° C.) | 20 | 20 | 20 | 20 | 20 |
| Acid modified | Acid modified polyolefin resin (B-1) | 10 | 10 | 10 | 10 | 10 |
| polyolefin resin | | | | | | |
| (B) | | | | | | |

| | | | | | | |
|---|---|---|---|---|---|---|
| | Mass ratio [(A)/(B)] | 90/10 | 90/10 | 90/10 | 90/10 | 90/10 |
| Characteristic | Nonvolatile component (percent by mass) | 45 | 45 | 40 | 45 | 45 |
| value | Weight average molecular weight | 60,000 | 75,000 | 100,000 | 90,000 | 86,000 |
| | Hydroxy group value | 0 | 14.2 | 31.3 | 43.3 | 24.2 |
| Evaluation | Storage stability | ◯ | ◯ | ◯ | ◯ | ◯ |
| | Initial adhesion (primer coating film) | ◯ | ◯ | ◯ | ◯ | ◯ |
| | Initial adhesion (composite coating film) | ◯ | ◯ | ◯ | ◯ | ◯ |
| | Adhesion after water resistance test (composite coating film) | ◯ | ◯ | ◯ | Δ | ◯ |
| | Pot life | ◯ | ◯ | ◯ | ◯ | ◯ |

| | | | | Example | Example | Example | Example |
|---|---|---|---|---|---|---|---|
| | | | | 15 | 16 | 17 | 18 |
| Resin composition | | | | (15) | (16) | (17) | (18) |
| Composition | Vinyl monomer | Vinyl monomer | 2-methacryloyoxyethyl | 0.2 | 0.2 | 0.2 | 0.2 |
| (parts by | mixture (A) | (a1) | acid phosphate | | | | |
| mass) | | Vinyl monomer | Ethyl acrylate | 49 | 48 | 51 | 48.5 |
| | | (a2) | | | | | |
| | | Vinyl monomer | 2-hydroxyethyl | 5 | | | |
| | | (a3) | methacrylate | | | | |
| | | | 2-hydroxypropyl | | 5 | 5 | 5 |
| | | | methacrylate | | | | |
| | | Other vinyl | Styrene | | 5.5 | | |
| | | monomers | Methyl methacrylate | 36 | 31 | 39 | 36 |
| | | | Methacrylic acid | | 0.3 | | |
| | | | Acrylic acid | | | | 0.3 |

| | | | | | |
|---|---|---|---|---|---|
| | Designed Tg (° C.) | 20 | 20 | 20 | 20 |
| Acid modified | Acid modified polyolefin resin (B-1) | 10 | 10 | 5 | 20 |
| polyolefin resin | | | | | |
| (B) | | | | | |

| | | | | | |
|---|---|---|---|---|---|
| | Mass ratio [(A)/(B)] | 90/10 | 90/10 | 95/5 | 80/20 |
| Characteristic | Nonvolatile component (percent by mass) | 45 | 45 | 45 | 45 |
| value | Weight average molecular weight | 79,000 | 67,000 | 60,000 | 70,000 |
| | Hydroxy group value | 23.9 | 20.2 | 20.4 | 20.3 |
| Evaluation | Storage stability | ◯ | ⊙ | ⊙ | ⊙ |
| | Initial adhesion (primer coating film) | ◯ | ◯ | ◯ | ◯ |
| | Initial adhesion (composite coating film) | ◯ | ◯ | ◯ | ◯ |
| | Adhesion after water resistance test (composite coating film) | ◯ | ◯ | ◯ | ◯ |
| | Pot life | ◯ | ◯ | ◯ | ◯ |

TABLE 3

| | | | | Example 19 | Example 20 | Example 21 | Example 22 |
|---|---|---|---|---|---|---|---|
| Resin composition | | | | (19) | (20) | (21) | (22) |
| Composition | Vinyl monomer | Vinyl monomer (a1) | 2-methacryloyoxyethyl | 0.2 | 0.2 | 0.2 | 0.2 |
| (parts by | mixture (A) | | acid phosphate | | | | |
| mass) | | Vinyl monomer (a2) | Ethyl acrylate | 48 | 48 | | |
| | | | n-butyl acrylate | | | 46 | 29 |
| | | | 2-ethylhexyl acrylate | | | | |
| | | Vinyl monomer (a3) | 2-hydroxyethyl | 5 | 5 | 5 | 5 |
| | | | methacrylate | | | | |
| | | Other vinyl | Styrene | 5.5 | 5.5 | 5.5 | 5.5 |
| | | monomers | Methyl methacrylate | 31 | 31 | 33 | 50 |
| | | | Methacrylic acid | 0.3 | 0.3 | 0.3 | 0.3 |
| | | Designed Tg (° C.) | | 20 | 20 | 0 | 30 |
| | Acid modified | Acid modified polyolefin resin (B-1) | | 10 | 10 | 10 | 10 |
| | polyolefin resin | Acid modified polyolefin resin (B-2) | | | | | |
| | (B) | Acid modified polyolefin resin (B-3) | | | | | |
| | Mass ratio [(A)/(B)] | | | 90/10 | 90/10 | 90/10 | 90/10 |
| Characteristic | Nonvolatile component (percent by mass) | | | 45 | 40 | 45 | 45 |
| value | Weight average molecular weight | | | 30,000 | 120,000 | 65,000 | 65,000 |
| | Hydroxy group value | | | 24.1 | 23.8 | 24.1 | 24.0 |
| Evaluation | Storage stability | | | ◯ | ◯ | ◯ | ◯ |
| | Initial adhesion (primer coating film) | | | ◯ | ◯ | ◯ | ◯ |
| | Initial adhesion (composite coating film) | | | ◯ | ◯ | ◯ | ◯ |
| | Adhesion after water resistance test (composite coating film) | | | ◯ | ◯ | ◯ | ◯ |
| | Pot life | | | ◯ | ◯ | ◯ | ◯ |
| | | | | Example 23 | Example 24 | Example 25 | Example 26 |
| Resin composition | | | | (23) | (24) | (25) | (26) |
| Composition | Vinyl monomer | Vinyl monomer (a1) | 2-methacryloyoxyethyl | 0.2 | 0.2 | 0.2 | 0.2 |
| (parts by | mixture (A) | | acid phosphate | | | | |
| mass) | | Vinyl monomer (a2) | Ethyl acrylate | | | 48 | 48 |
| | | | n-butyl acrylate | | | | |
| | | | 2-ethylhexyl acrylate | 39 | 25 | | |
| | | Vinyl monomer (a3) | 2-hydroxyethyl | 5 | 5 | 5 | 5 |
| | | | methacrylate | | | | |
| | | Other vinyl | Styrene | 5.5 | 5.5 | 5.5 | 5.5 |
| | | monomers | Methyl methacrylate | 40 | 54 | 31 | 31 |
| | | | Methacrylic acid | 0.3 | 0.3 | 0.3 | 0.3 |

| | | | | | |
|---|---|---|---|---|---|
| | Designed Tg (° C.) | 0 | 30 | 20 | 20 |
| Acid modified | Acid modified polyolefin resin (B-1) | 10 | 10 | | |
| polyolefin resin | Acid modified polyolefin resin (B-2) | | | 10 | |
| (B) | Acid modified polyolefin resin (B-3) | | | | 10 |

| | | | | | |
|---|---|---|---|---|---|
| | Mass ratio [(A)/(B)] | 90/10 | 90/10 | 90/10 | 90/10 |
| Characteristic | Nonvolatile component (percent by mass) | 45 | 45 | 45 | 45 |
| value | Weight average molecular weight | 70,000 | 70,000 | 65,000 | 70,000 |
| | Hydroxy group value | 23.8 | 23.9 | 24.2 | 24.1 |
| Evaluation | Storage stability | ◯ | ◯ | ◯ | ◯ |
| | Initial adhesion (primer coating film) | ◯ | ◯ | ◯ | ◯ |
| | Initial adhesion (composite coating film) | ◯ | ◯ | ◯ | ◯ |
| | Adhesion after water resistance test (composite coating film) | ◯ | ◯ | ◯ | ◯ |
| | Pot life | ◯ | ◯ | ◯ | ◯ |

TABLE 4

| | | | | Comparative | Comparative | Comparative | Comparative |
|---|---|---|---|---|---|---|---|
| | | | | Example 1 | Example 2 | Example 3 | Example 4 |
| Resin composition | | | | (R1) | (R2) | (R3) | (R4) |
| Composition | Vinyl monomer | Vinyl monomer (a1) | 2-methacryloyoxyethyl | 0.2 | 0.2 | 0.2 | 0.2 |
| (parts by | mixture | | acid phosphate | | | | |
| mass) | | Vinyl monomer (a2) | Ethyl acrylate | 53 | 26 | 74 | 28 |
| | | | n-butyl acrylate | | | | |
| | | Vinyl monomer (a3) | 2-hydroxyethyl | 5 | 5 | 5 | 5 |
| | | | methacrylate | | | | |
| | | | 4-hydroxybutyl acrylate | | | | |
| | | Other vinyl | Styrene | 5.5 | 5.5 | 5.5 | 5.5 |
| | | monomers | Methyl methacrylate | 36 | 13 | 5 | 51 |
| | | | Methacrylic acid | 0.3 | 0.3 | 0.3 | 0.3 |
| | | | t-butyl methacrylate | | | | |
| | | | n-butyl methacrylate | | | | |

| | | | | | |
|---|---|---|---|---|---|
| | Designed Tg (° C.) | 20 | 20 | −10 | 50 |
| Acid modified | Acid modified polyolefin resin (B-1) | | 50 | 10 | 10 |
| polyolefin resin | | | | | |
| (B) | | | | | |

| | | | | | |
|---|---|---|---|---|---|
| | Polyether polyol resin | | | | |
| | Mass ratio [(vinyl monomer mixture)/(acid modified polyolefin | 100/0 | 50/50 | 90/10 | 90/10 |
| | resin)] | | | | |
| Characteristic | Nonvolatile component (percent by mass) | 45 | 45 | 45 | 45 |
| value | Weight average molecular weight | 58,000 | 88,000 | 65,000 | 70,000 |
| | Hydroxy group value | 23.1 | 22.5 | 23.2 | 23.3 |
| Evaluation | Storage stability | ◯ | X | Δ | ◯ |
| | Initial adhesion (primer coating film) | Δ | ◯ | ◯ | Δ |
| | Initial adhesion (composite coating film) | Δ | Δ | Δ | Δ |
| | Adhesion after water resistance test (composite coating film) | X | Δ | X | X |
| | Pot life | ◯ | ◯ | ◯ | ◯ |

| | | | | Comparative | Comparative | Comparative |
|---|---|---|---|---|---|---|
| | | | | Example 5 | Example 6 | Example 7 |
| Resin composition | | | | (R5) | (R6) | |
| | | | | | | (R7) |
| Composition | Vinyl monomer | Vinyl monomer (a1) | 2-methacryloyoxyethyl | | | 1 |
| (parts by | mixture | | acid phosphate | | | |
| mass) | | Vinyl monomer (a2) | Ethyl acrylate | 48 | | |
| | | | n-butyl acrylate | | | 25 |
| | | Vinyl monomer (a3) | 2-hydroxyethyl | 5 | | |
| | | | methacrylate | | | |
| | | | 4-hydroxybutyl acrylate | | 27 | |
| | | Other vinyl | Styrene | 5.5 | | |
| | | monomers | Methyl methacrylate | 31.2 | 32 | 49 |
| | | | Methacrylic acid | 0.3 | | |
| | | | t-butyl methacrylate | | 31 | |
| | | | n-butyl methacrylate | | | 5 |

| | | | | |
|---|---|---|---|---|
| | Designed Tg (° C.) | 20 | 20 | 30 |
| Acid modified | Acid modified polyolefin resin (B-1) | 10 | 10 | |
| polyolefin resin | | | | |
| (B) | | | | |

| | | | | |
|---|---|---|---|---|
| | Polyether polyol resin | | | 20 |
| | Mass ratio [(vinyl monomer mixture)/(acid modified polyolefin | 90/10 | 90/10 | 100/0 |
| | resin)] | | | |
| Characteristic | Nonvolatile component (percent by mass) | 45 | 50 | 60 |
| value | Weight average molecular weight | 68,000 | 30,000 | 30,000 |
| | Hydroxy group value | 23.2 | 74 | 34 |
| Evaluation | Storage stability | ◯ | ◯ | ◯ |
| | Initial adhesion (primer coating film) | Δ | Δ | ◯ |
| | Initial adhesion (composite coating film) | Δ | Δ | Δ |
| | Adhesion after water resistance test (composite coating film) | X | X | Δ |
| | Pot life | ◯ | ◯ | X |

The acid modified polyolefin resins and the polyether polyol resin in the above Tables 1 to 4 are as follows.

“Acid modified polyolefin resin (B-1)”: AUROREN 350S (maleic anhydride modified polyolefin manufactured by Nippon Paper Industries Co., Ltd.)

“Acid modified polyolefin resin (B-2)”: HIROS-X·US-1035 (acid modified polyolefin manufactured by Seiko PMC Corp.)

“Acid modified polyolefin resin (B-3)”: HIROS-X·ZS-1205″ (acid modified polyolefin manufactured by Seiko PMC Corp.)

“Polyether polyol resin”: PTG650G (polyether polyol manufactured by Hodogaya Chemical Co., Ltd.)

It was found that the resin composition of each of Examples 1 to 26 according to the present invention had excellent storage stability, and that the coating film thereof had a high adhesion to the substrate and the top coating film and an excellent water resistance.

On the other hand, Comparative Example 1 was an example in which the acid modified polyolefin resin (B), which was an essential raw material of the present invention, was not used, and it was found that the water resistance of the coating film was not sufficient.

Comparative Example 2 was an example in which the mass ratio [(A)/(B)] of the vinyl monomer mixture to the acid modified polyolefin resin was out of a range of 99/1 to 60/40, and it was found that the storage stability was not sufficient.

Comparative Examples 3 and 4 were examples in each of which the glass transition temperature (designed Tg) calculated by FOX's equation was out of a range of −5° C. to 45° C., and it was found that the water resistance of the coating film was not sufficient.

Comparative Example 5 was an example in which the phosphorus atom-containing vinyl monomer (a1), which was an essential raw material of the present invention, was not used, and it was found that the water resistance of the coating film was not sufficient.

Comparative Example 6 was an example in which the phosphorus atom-containing vinyl monomer (a1) and the vinyl monomer (a2), each of which was an essential raw material of the present invention, were not used, and it was found that the water resistance of the coating film was not sufficient.

Comparative Example 7 was an example in which the acid modified polyolefin resin (B), which was an essential raw material of the present invention, was not used and in which a polyether polyol resin was used, and it was found that the pot life, which was required for application of coating materials, was not good and that the water resistance of the coating film was also not sufficient.

1. A resin composition obtained by a polymerization reaction of a vinyl monomer mixture in the presence of an acid modified polyolefin resin, the vinyl monomer mixture containing as an essential component, a phosphorus atom-containing vinyl monomer and at least one type of vinyl monomer selected from the group consisting of ethyl acrylate, n-butyl acrylate, and 2-ethylhexyl acrylate and having a glass transition temperature of −5° C. to 45° C. which is calculated by FOX's equation,
wherein the mass ratio of the vinyl monomer mixture to the acid modified polyolefin resin is in a range of 99/1 to 60/40.

2. The resin composition according to claim 1, wherein the mass rate of the vinyl monomer in the vinyl monomer mixture is in a range of 0.01 to 1.5 percent by mass, and the mass rate of the vinyl monomer is in a range of 20 to 70 percent by mass.

3. The resin composition according to claim 1, wherein the vinyl monomer mixture contains a vinyl monomer having a hydroxy group.

4. A primer coating material comprising: the resin composition according to claim 1.

5. A plastic molded article coated with the primer coating material according to claim 4.

6. The plastic molded article according to claim 5, wherein the plastic is a glass fiber reinforced plastic.

7. The resin composition according to claim 2, wherein the vinyl monomer mixture contains a vinyl monomer having a hydroxy group.

8. A primer coating material comprising the resin composition according claim 2.

9. A primer coating material comprising the resin composition according to claim 3.

10. A primer coating material comprising the resin composition according to claim 7.

11. A plastic molded article coated with the primer coating material according to claim 8.

12. A plastic molded article coated with the primer coating material according to claim 9.

13. A plastic molded article coated with the primer coating material according to claim 10.
